(19) United States
(12) Patent Application Publication
(10) Pub. No.: US 2025/0329918 A1
(43) Pub. Date: Oct. 23, 2025

(54) ELECTRONIC DEVICE INCLUDING ANTENNA

(71) Applicant: SAMSUNG ELECTRONICS CO., LTD., Suwon-si (KR)

(72) Inventors: Jungyouel BANG, Suwon-si (KR); Hojun Bae, Suwon-si (KR); Jeonghoon Lee, Suwon-si (KR); Yongjun Choi, Suwon-si (KR)

(73) Assignee: SAMSUNG ELECTRONICS CO., LTD., Suwon-si (KR)

(21) Appl. No.: 19/187,379

(22) Filed: Apr. 23, 2025

Related U.S. Application Data
(63) Continuation of application No. PCT/KR2025/004028, filed on Mar. 28, 2025.

(30) Foreign Application Priority Data
Apr. 17, 2024 (KR) 10-2024-0051157
May 23, 2024 (KR) 10-2024-0067336

(51) Int. Cl. H01Q 1/27; H01Q 1/42; H01Q 7/00

(52) U.S. Cl. CPC H01Q 1/273; H01Q 1/42; H01Q 7/00

(57) ABSTRACT

An electronic device may include: a housing; a display in the housing; a battery in the housing; and an antenna between the display and the battery, wherein the antenna includes: an antenna pattern layer comprising an antenna pattern; a first sheet overlapping a portion of a first surface of the antenna pattern layer; and a second sheet overlapping a portion of a second surface of the antenna pattern layer, the second surface being opposite to the first surface of the antenna pattern layer and at least partially overlapping the first sheet. A portion of the antenna pattern may not be covered by the first sheet and the second sheet and may be exposed to outside of the first sheet and the second sheet.

### CROSS-REFERENCE TO RELATED APPLICATIONS

This application is a continuation application of International Application No. PCT/KR 2025/004028, filed on Mar. 28, 2025, in the Korean Intellectual Property Receiving Office, which claims priority to Korean Patent Application No. 10-2024-0051157, filed on Apr. 17, 2024, in the Korean Intellectual Property Office, and Korean Patent Application No. 10-2024-0067336, filed on May 23, 2024, in the Korean Intellectual Property Office, the disclosures of which are incorporated by reference herein in their entireties.

### BACKGROUND

### 1. Field

The disclosure relates to an electronic device including an antenna.

### 2. Description of Related Art

An electronic device (e.g., a wearable electronic device) may include a near field communication (NFC) antenna and a printed circuit board on which the NFC antenna is disposed. For example, the NFC antenna may be disposed on the printed circuit board. The electronic device may perform short-range wireless communication by using the NFC antenna.

The above-mentioned information can be provided as a related art for helping an understanding of the disclosure. No determination has been made, and no assertion is made, as to whether any of the above-mentioned information might be applicable as prior art with regard to the disclosure.

### SUMMARY

According to an aspect of the disclosure, an electronic device may include: a housing; a display in the housing; a battery in the housing; and an antenna between the display and the battery, wherein the antenna includes: an antenna pattern layer comprising an antenna pattern; a first sheet overlapping a portion of a first surface of the antenna pattern layer; and a second sheet overlapping a portion of a second surface of the antenna pattern layer, the second surface being opposite to the first surface of the antenna pattern layer and at least partially overlapping the first sheet. A portion of the antenna pattern may not be covered by the first sheet and the second sheet and may be exposed to outside of the first sheet and the second sheet.

According to an aspect of the disclosure, an electronic device may include: a housing; and an antenna in the housing, wherein the antenna includes: an antenna pattern layer comprising an antenna pattern; a first sheet overlapping a portion of a first surface of the antenna pattern layer; and a second sheet overlapping a portion of a second surface of the antenna pattern layer, the second surface being opposite to the first surface of the antenna pattern layer and at least partially overlapping the first sheet. A portion of the antenna pattern may not be overlapped by the first sheet and the second sheet and may be exposed to outside of the first sheet and the second sheet.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to one or more embodiments;

FIG. 2 is a front perspective view of an electronic device according to one or more embodiments of the disclosure;

FIG. 3 is a rear perspective view of an electronic device according to one or more embodiments of the disclosure;

FIG. 4 is an exploded perspective view of an electronic device according to one or more embodiments of the disclosure;

FIG. 5 is a view showing an electronic device according to one or more embodiments of the disclosure;

FIG. 6A is a view showing an antenna according to one or more embodiments of the disclosure;

FIG. 6B is a view showing an antenna according to one or more embodiments of the disclosure;

FIG. 6C is a view showing an antenna according to one or more embodiments of the disclosure;

FIG. 7A is a view showing an antenna according to one or more embodiments of the disclosure;

FIG. 7B is a view showing an antenna according to one or more embodiments of the disclosure;

FIG. 7C is a view showing an antenna according to one or more embodiments of the disclosure;

FIG. 7D is a view showing a sheet including slits according to one or more embodiments;

FIG. 8 is a view showing an electronic device according to one or more embodiments of the disclosure;

FIG. 9 is a view showing an antenna according to one or more embodiments of the disclosure.

FIG. 10A is a view showing an antenna according to one or more embodiments;

FIG. 10B is a view showing an antenna according to one or more embodiments;

FIG. 10C is a view showing an antenna according to one or more embodiments;

FIG. 11 is a view showing a wireless signal of an electronic device according to one or more embodiments of the disclosure;

FIG. 12 is a view showing a signal passing region according to one or more embodiments of the disclosure;

FIG. 13 is a view showing an electronic device according to one or more comparative embodiments; and

FIG. 14 is a view showing an electronic device according to one or more embodiments of the disclosure.

### DETAILED DESCRIPTION

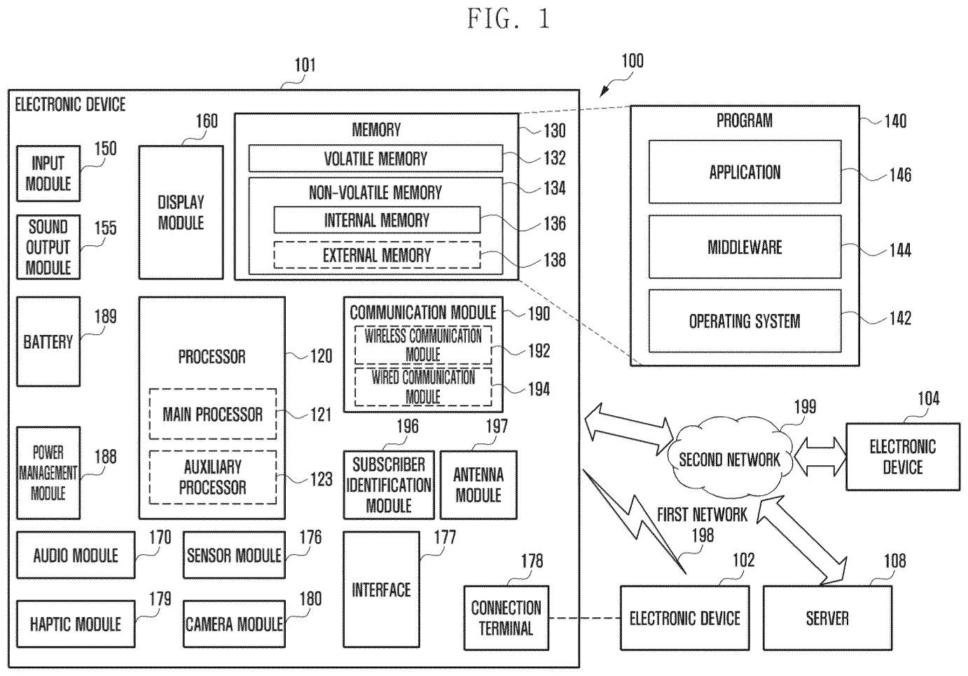

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PM IC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a R FIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

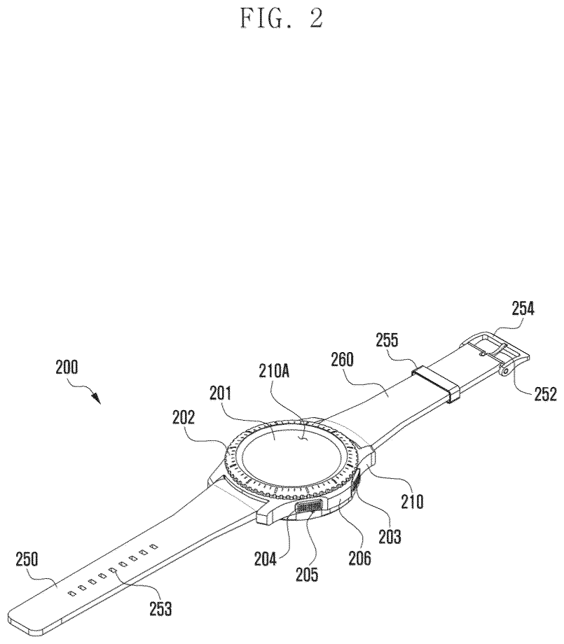

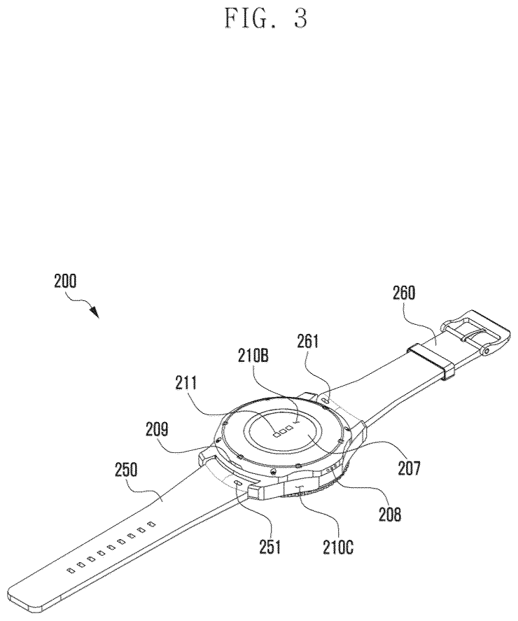

FIG. 2 is a front perspective view of an electronic device 200 according to one or more embodiments of the disclosure. FIG. 3 is a rear perspective view of an electronic device 200 according to one or more embodiments of the disclosure.

Referring to FIG. 2 and FIG. 3, an electronic device 200 according to one or more embodiments may include a housing 210 including a first surface (or a front surface) 210A, a second surface (or a rear surface) 210B, and a side surface 210C surrounding a space between the first surface 210A and the second surface 210B, and binding members 250 and 260 connected to at least portions of the housing 210 and configured to allow the electronic device 200 to be worn on a region (e.g., the wrist, the ankle, or the like) of the body of a user. In one or more embodiments, the housing 210 may also be referred to as a structure which forms a portion of the first surface 210A, the second surface 210B, and the side surface 210C in FIG. 2. According to one or more embodiments, the first surface 210A may be formed by a front plate 201 (e.g., a glass plate including various coating layers or a polymer plate), at least a portion of which is substantially transparent. The second surface 210B may be formed by a substantially opaque rear plate 207. For example, the rear plate 207 may be formed by coated or colored glass, ceramic, polymer, metal (e.g., aluminum, stainless steel (STS), or magnesium), or a combination of at least two of the above materials. The side surface 210C may be coupled to the front plate 201 and the rear plate 207, and may be formed by a side bezel structure (or a “side member”) 206 including metal and/or polymer. In some embodiments, the rear plate 207 and the side bezel structure 206 may be integrally formed, and may include a same material (e.g., a metal material such as aluminum). The binding members 250 and 260 may be formed of various materials and in various forms. Each of the binding members may be formed in an integral type and may be formed to have a plurality of unit links coupled to be movable with respect to each other, by woven fabrics, leather, rubber, urethane, metal, ceramic, or a combination of at least two of the materials.

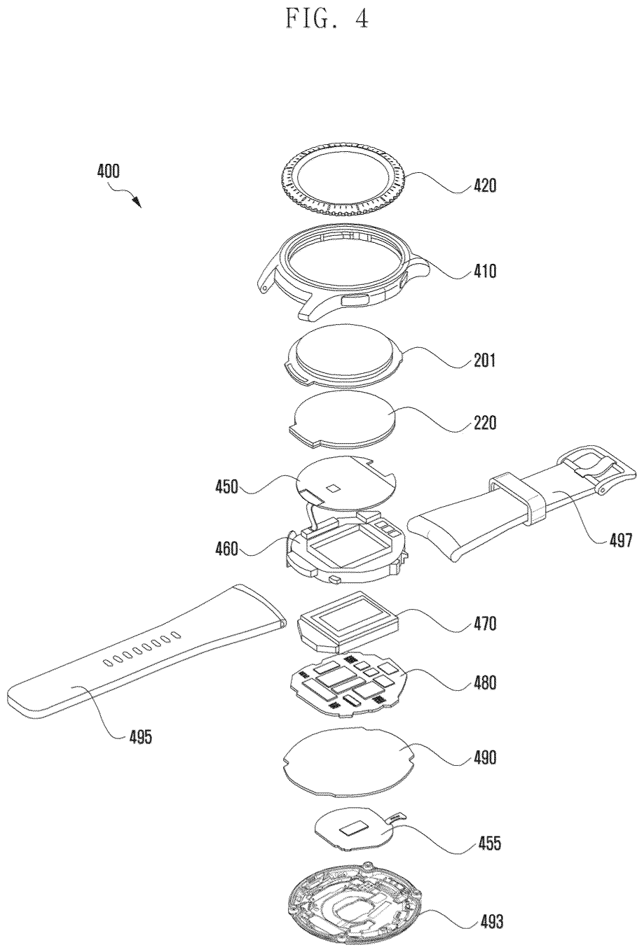

According to one or more embodiments, the electronic device 200 may include at least one of a display 220 (see FIG. 4), audio modules 205 and 208, a sensor module 211, key input devices 202, 203, and 204, and a connector hole 209. In some embodiments, the electronic device 200 may be configured such that at least one (e.g., the key input devices 202, 203, and 204, the connector hole 209, or the sensor module 211) of the elements is omitted therefrom or other elements are additionally included therein.

For example, the display 220 may be exposed through a substantial portion of the front plate 201. The shape of the display 220 may be a shape corresponding to the shape of the front plate 201, and may have various shapes such as a circle, an ellipse, or a polygon. The display 220 may be coupled to or disposed adjacent to a touch detection circuit, a pressure sensor capable of measuring the intensity (pressure) of touch, and/or a fingerprint sensor.

The audio modules 205 and 208 may include a microphone hole 205 and a speaker hole 280. A microphone for obtaining external sound may be disposed in the microphone hole 205, and in some embodiments, a plurality of microphones may be arranged to be able to detect the direction of sound. The speaker hole 208 may be used as an external speaker and a receiver for a phone call.

The sensor module 211 may generate an electrical signal or a data value corresponding to an internal operation state of the electronic device 200 or an external environmental state. For example, the sensor module 211 may include a biometric sensor module 211 (e.g., an HRM sensor) disposed on the second surface 210B of the housing 210. The electronic device 200 may further include a sensor module not illustrated, for example, at least one of a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

The key input devices 202, 203, and 204 may include a wheel key 202 which is disposed on the first surface 210A of the housing 210 and is rotatable in at least one direction, and/or side key buttons 203 and 204 arranged on the side surface 210C of the housing 210. The wheel key may have a shape corresponding to the shape of the front plate 202. In one or more embodiments, the electronic device 200 may not include a portion or the whole of the key input devices 202, 203, and 204 mentioned above, and the key input device 202, 203, or 204 not included therein may be implemented as a different type, such as a soft key, on the display 220. The connector hole 209 may include other connector holes capable of accommodating a connector (for example, a USB connector) for transmitting or receiving electric power and/or data to or from an external electronic device and capable of accommodating a connector for transmitting or receiving an audio signal to or from an external electronic device. For example, the electronic device 200 may further include a connector cover covering at least a portion of the connector hole 209 and blocking outer foreign materials from being introduced into the connector hole.

The binding members 250 and 260 may be detachably bound to at least partial regions of the housing 210 by using locking members 251 and 261. The binding members 250 and 260 may include one or more of a fixation member 252, a fixation member fastening hole 253, a band guide member 254, and a band fixation ring 255.

The fixation member 252 may be configured to allow the housing 210 and the binding members 250 and 260 to be fixed to a region (e.g., the wrist or the ankle) of the body of a user. The fixation member fastening hole 253 may be formed to correspond to the fixation member 252 so that the housing 210 and the binding members 250 and 260 are fixed to a region of the body of a user. The band guide member 254 may be configured to limit a motion range of the fixation member 252 when the fixation member 252 is fastened to the fixation member fastening hole 253, and thus the binding members 250 and 260 may be bound to a region of the body of a user in a state of being in close contact therewith. The band fixation ring 255 may limit a motion range of the binding members 250 and 260 in a state where the fixation member 252 and the fixation member fastening hole 253 are fastened to each other.

FIG. 4 is an exploded perspective view of an electronic device 400 illustrated in FIG. 2.

Referring to FIG. 4, an electronic device 400 may include a side bezel structure 410, a wheel key 420, a front plate 201, a display 220, a first antenna 450, a second antenna 455, a support member 460 (e.g., a bracket), a battery 470, a printed circuit board 480, a sealing member 490, a rear plate 493, and binding members 495 and 497. At least one of elements of the electronic device 400 may be the same as or similar to at least one of elements of the electronic device 200 in FIG. 2 or FIG. 3, and overlapping descriptions will be omitted hereinafter. The support member 460 may be disposed in the electronic device 400 to be connected to the side bezel structure 410 or to be integrally formed with the side bezel structure 410. For example, the support member 460 may be formed of a metal material and/or a non-metal (e.g., polymer) material. The support member 460 may have one surface to which the display 220 is coupled, and the other surface to which the printed circuit board 480 is coupled. A processor (e.g., the processor 120 in FIG. 1), a memory (e.g., the memory 130 in FIG. 1), and/or an interface (e.g., the interface 177 in FIG. 1) may be mounted on the printed circuit substrate (printed circuit board 480). For example, the processor may include one or more of a central processing device, an application processor, a graphics processing unit (GPU), an application processor signal processing part, and a communication processor.

For example, the memory may include a volatile memory or a non-volatile memory. For example, the interface may include a high definition multimedia interface (HDMI), a universal serial bus (USB) interface, an SD card interface, and/or an audio interface. For example, the interface may electrically or physically connect the electronic device 400 to an external electronic device, and may include a USB connector, an SD card/MMC connector, or an audio connector.

The battery 470 may be a device for supplying electric power to at least one element of the electronic device 400, and for example, may include a non-rechargeable primary cell, a rechargeable secondary cell, or a fuel cell. For example, at least a portion of the battery 470 may be disposed on a plane substantially identical to the printed circuit board 480. The battery 470 may be integrally disposed inside the electronic device 200, or may also be disposed to be detachable/attachable from/to the electronic device 200.

The first antenna 450 may be disposed between the display 220 and the support member 460. For example, the first antenna 450 may include a near field communication (NFC) antenna, a wireless charging antenna, and/or a magnetic secure transmission (MST) antenna. For example, the first antenna 450 may perform short-range communication with an external device, or may wirelessly transmit or receive electric power required for charging, and may transmit a short-range communication signal or a magnetic-based signal including payment data. In one or more embodiments, an antenna structure may be formed by a portion of the side bezel structure 410 and/or the support member 460, or a combination thereof.

The second antenna 455 may be disposed between the printed circuit board 480 and the rear plate 493. For example, the second antenna 455 may include a near field communication (NFC) antenna, a wireless charging antenna, and/or a magnetic secure transmission (MST) antenna. For example, the second antenna 455 may perform short-range communication with an external device, or may wirelessly transmit or receive electric power required for charging, and may transmit a short-range communication signal or a magnetic-based signal including payment data. In another embodiment, an antenna structure may be formed by a portion of the side bezel structure 410 and/or the rear plate 493, or a combination thereof.

The sealing member 490 may be disposed between the side bezel structure 410 and the rear plate 493. The sealing member 490 may be configured to block moisture and foreign materials from being introduced from the outside into a space surrounded by the side bezel structure 410 and the rear plate 493.

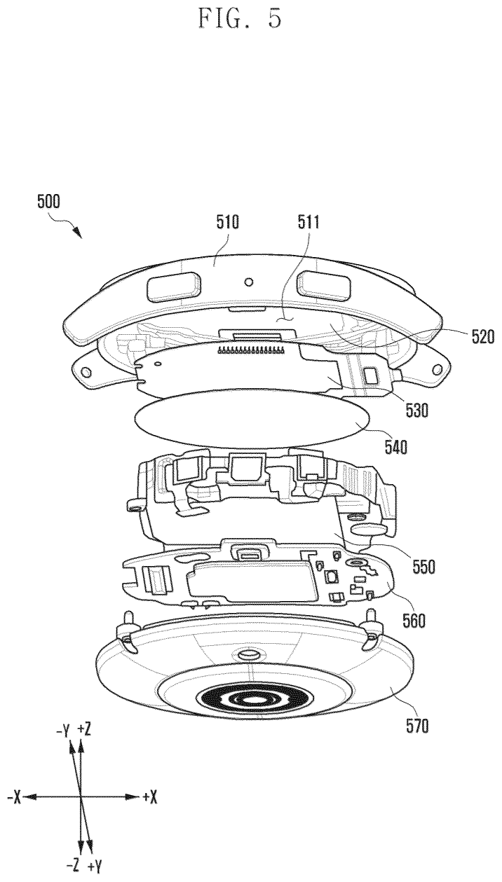

FIG. 5 is a view showing an electronic device 500 according to one or more embodiments of the disclosure.

In describing an electronic device 500 according to one or more embodiments of the disclosure, the height direction of the electronic device 500 may mean the Z-axis direction.

The electronic device 500 in FIG. 5 may refer to the electronic device 101 in FIG. 1, or may include at least a portion of elements of the electronic device 101 in FIG. 1.

The electronic device 500 in FIG. 5 may refer to the electronic device 200 in FIG. 2 and FIG. 3, or may include at least a portion of elements of the electronic device 200 in FIG. 2 and FIG. 3.

The electronic device 500 in FIG. 5 may refer to the electronic device 400 in FIG. 4, or may include at least a portion of elements of the electronic device 400 in FIG. 4.

The electronic device 500 according to one or more embodiments of the disclosure may include a housing 510, a display 520, a flexible circuit board 530, an antenna 540, a battery 550, a printed circuit board 560, and/or a rear cover 570.

The housing 510 in FIG. 5 may refer to the housing 210 in FIG. 2, FIG. 3, and FIG. 4, or may include at least a portion of elements of the housing 210 in FIG. 2, FIG. 3, and FIG. 4.

In one or more embodiments, the housing 510 may form the exterior of the electronic device 500. The housing 510 may include an arrangement space 511 in which elements of the electronic device 500 can be arranged.

The display 520 in FIG. 5 may refer to the display 220 in FIG. 2, FIG. 3, and FIG. 4, or may include at least a portion of elements of the display 220 in FIG. 2, FIG. 3, and FIG. 4.

In one or more embodiments, the display 520 may visually provide information to the outside (e.g., a user) of the electronic device 500. According to one or more embodiments, the display 520 may include a touch sensor configured to detect a touch, or a pressure sensor configured to measure the intensity of a force generated by the touch.

In one or more embodiments, the display 520 may be disposed in the housing 510. The housing 510 may include a glass member (e.g., a window cover) for covering the display 520.

In one or more embodiments, the flexible circuit board 530 may be electrically connected to the display 520. The flexible circuit board 530 may be electrically connected to the display 520, and may have a controller disposed thereon to control the display 520. In one or more embodiments, the display 520 and the flexible circuit board 530 may form a display module.

The antenna 540 in FIG. 5 may include at least a portion of elements of the first antenna 450 in FIG. 4 or the second antenna 455 in FIG. 4.

In one or more embodiments, the antenna 540 may be a near field communication (NFB) antenna for short-range wireless communication. In one or more embodiments, the antenna 540 may be disposed between the display 520 and the battery 550.

The battery 550 in FIG. 5 may refer to the battery 470 in FIG. 4, or may include at least a portion of elements of the battery 470 in FIG. 4.

In one or more embodiments, the battery 550 may supply electric power to at least one element of the electronic device 500. According to one or more embodiments, the battery 550 may include a non-rechargeable primary battery, a rechargeable secondary battery, or a fuel cell.

In one or more embodiments, the battery 550 may be disposed in the housing 510.

In one or more embodiments, the printed circuit board 560 may refer to the printed circuit board 480 in FIG. 4, or may include at least a portion of elements of the printed circuit board 480 in FIG. 4.

In one or more embodiments, at least one element of the electronic device 500 may be mounted on the printed circuit board 560. For example, a processor (e.g., the processor 120 in FIG. 1), a memory (e.g., the memory 130 in FIG. 1), and/or an interface (e.g., the interface 177 in FIG. 1) may be mounted on the printed circuit substrate (printed circuit board 560).

The rear cover 570 in FIG. 5 may refer to the rear plate 493 in FIG. 4, or may include at least a portion of elements of the rear plate 493 in FIG. 4.

In one or more embodiments, the rear cover 570 may be disposed to cover at least a portion of the housing 510. For example, the rear cover 570 may be a plate for covering at least a portion of the housing 510.

Although FIG. 5 illustrates that the rear cover 570 and the housing 510 are separate elements, it is not limited thereto, and the housing 510 may also be configured to include the rear cover 570.

In one or more embodiments, the electronic device 500 may be a wearable device configured to be detached from or attached to a region (e.g., the wrist) of the body of a user.

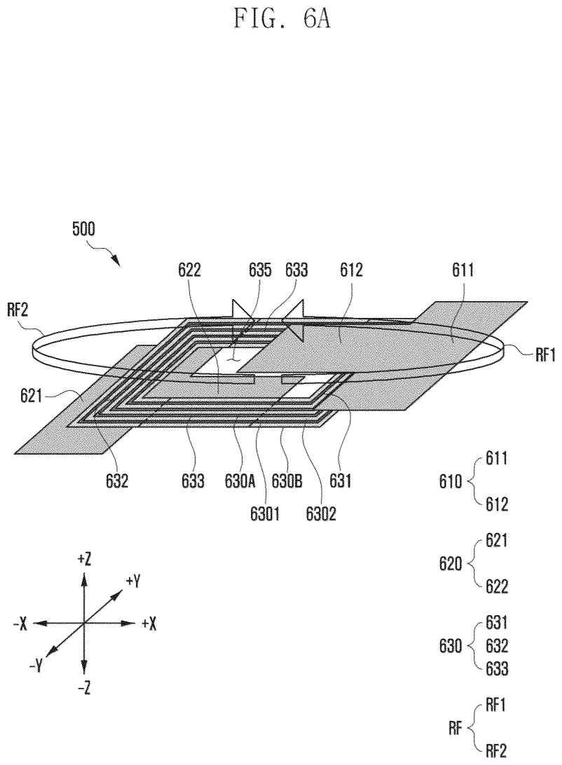

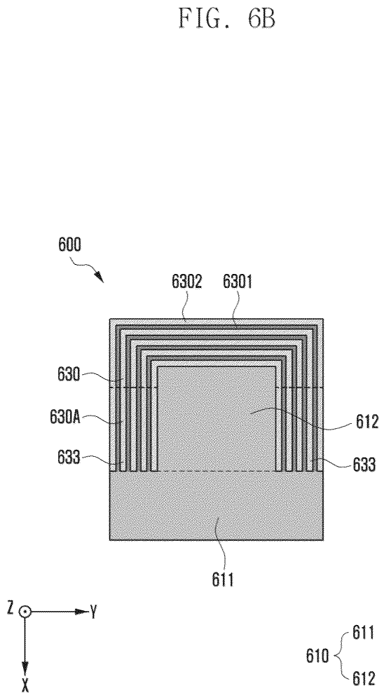

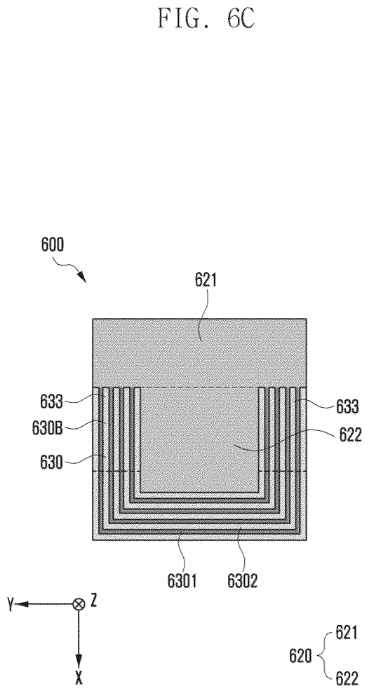

FIG. 6A, FIG. 6B, and FIG. 6C are views showing an antenna 600 according to one or more embodiments of the disclosure.

FIG. 6A is an exploded perspective view showing an antenna 600 according to one or more embodiments. FIG. 6B is a view showing a first surface 630A of an antenna pattern layer 630 according to one or more embodiments. FIG. 6C is a view showing a second surface 630B of an antenna pattern layer 630 according to one or more embodiments.

In describing an antenna 600 according to one or more embodiments of the disclosure, the height direction of the antenna 600 may mean the Z-axis direction.

The antenna 600 in FIG. 6A, FIG. 6B, and FIG. 6C may refer to the antenna 540 in FIG. 5, or may include at least a portion of the antenna 540 in FIG. 5.

The antenna 600 according to one or more embodiments of the disclosure may include a first sheet 610, a second sheet 620, and/or an antenna pattern layer 630.

In one or more embodiments, the antenna pattern layer 630 may include an antenna pattern 6302 for generating a wireless signal and/or a base layer 6301 having at least a portion on which the antenna pattern 6302 is formed.

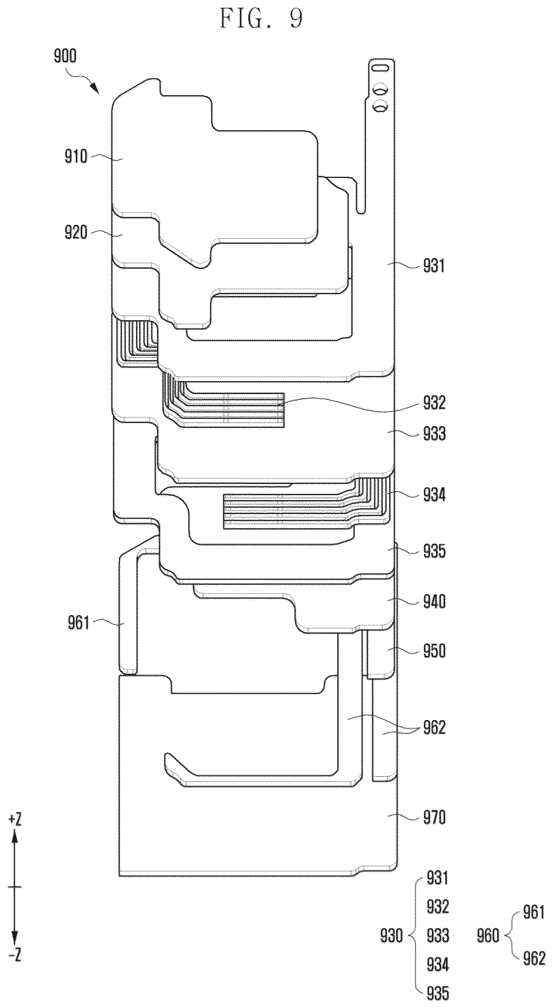

In one or more embodiments, the antenna pattern layer 630 may also be formed in a shape in which a coil is wound. In case that the antenna pattern layer 630 is formed in a shape in which a coil is wound, the antenna pattern layer 630 may not include a separate base layer (e.g., the base layer 933 in FIG. 9).

In one or more embodiments, with reference to the height direction (e.g., the Z-axis direction) of the antenna 600, the second sheet 620, the antenna pattern layer 630, and the first sheet 610 may be stacked in the described order.

In one or more embodiments, the first sheet 610 and the second sheet 620 may be arranged on opposite surfaces of the antenna pattern layer 630.

In one or more embodiments, the first sheet 610 may be disposed to cover at least a portion of a first surface 630A of the antenna pattern layer 630.

In one or more embodiments, the second sheet 620 may be disposed to cover at least a portion of a second surface 630B of the antenna pattern layer 630, which is a surface opposite to the first surface 630A.

In one or more embodiments, each of the first sheet 610 and the second sheet 620 may include a magnetic material. For example, the first sheet 610 and the second sheet 620 may include ferrite sheets.

In one or more embodiments, each of the first sheet 610 and the second sheet 620 may also not include a magnetic material. For example, each of the material included in the first sheet 610 and the material included in the second sheet 620 is not be limited to the magnetic material. In one or more embodiments, each of the first sheet 610 and the second sheet 620 may be formed of a conductive material or ferroelectrics.

In one or more embodiments, the first sheet 610 and the second sheet 620 may perform a function to prevent other components of the electronic device 500 (see FIG. 5) from affecting a wireless signal RF generated by the antenna 600 or reduce the influence thereof.

In one or more embodiments, at least a partial region of the antenna pattern layer 630 may not overlap the first sheet 610 and the second sheet 620 when viewed in the Z-axis direction. For example, at least a partial region of the antenna pattern layer 630 may not be covered by the first sheet 610 and the second sheet 620.

In one or more embodiments, the antenna pattern layer 630 may include a first region 631, a second region 632, and/or a third region 633.

In one or more embodiments, the first region 631 may be a region (e.g., a region covered by the first sheet 610) of the first sheet 610 or the second sheet 620, which overlaps the first sheet 610. For example, the antenna pattern layer 630 may overlap the first sheet 610 positioned on the first surface 630A of the antenna pattern layer 630, in the first region 631.

In one or more embodiments, the second region 632 may be a region (e.g., a region covered by the second sheet 620) of the first sheet 610 or the second sheet 620, which overlaps the second sheet 620. For example, the antenna pattern layer 630 may overlap the second sheet 620 positioned on the second surface 630B of the antenna pattern layer 630, in the second region 632.

In one or more embodiments, the third region 633 may be a region (e.g., a region not covered by the first sheet 610 and the second sheet 620) which does not overlap the first sheet 610 and the second sheet 620. For example, the antenna pattern layer 630 may not overlap both of the first sheet 610 and the second sheet 620, in the third region 633.

In one or more embodiments, the first sheet 610 may include a first part 611 and/or a second part 612.

In one or more embodiments, the first part 611 may be a portion overlapping at least a portion of the antenna pattern layer 630.

In one or more embodiments, the second part 612 may be a portion extending from the first part 611 and overlapping the second sheet 620. For example, the second part 612 may be formed substantially perpendicular to the first part 611.

In one or more embodiments, the second sheet 620 may include a third part 621 and/or a fourth part 622.

In one or more embodiments, the third part 621 may be a portion overlapping at least a portion of the antenna pattern layer 630.

In one or more embodiments, the fourth part 622 may be a portion extending from the third part 621 and overlapping the first sheet 610. For example, the fourth part 622 may be formed substantially perpendicular to the third part 621.

Referring to FIG. 6A, the antenna pattern layer 630 may include a central space 635.

In one or more embodiments, the antenna pattern layer 630 may include an antenna pattern 6302 disposed to have a quadrilateral loop shape extending to surround the central space 635.

In one or more embodiments, the third region 633 of the antenna pattern layer 630 may be positioned in one direction (e.g., the negative Y-axis direction) and/or the other direction (e.g., the positive Y-axis direction) with reference to the central space 635.

In one or more embodiments, the second part 612 of the first sheet 610 and the fourth part 622 of the second sheet 620 may be arranged to overlap each other in the central space 635.

In one or more embodiments, each of the second part 612 of the first sheet 610 and the fourth part 622 of the second sheet 620 may have a shape substantially identical to the shape of the central space 635.

In one or more embodiments, the second part 612 of the first sheet 610 and/or the fourth part 622 of the second sheet 620 may also further extend in one direction (e.g., the negative Y-axis direction) and/or the other direction (e.g., the positive Y-axis direction) with reference to the central space 635, compared to the central space 635.

In one or more embodiments, the wireless signal RF may be generated by the antenna pattern layer 630. The wireless signal RF may include a first wireless signal RF1 and/or a second wireless signal RF2.

In one or more embodiments, the wireless signal RF may include a radio frequency (RF) signal generated by an NFC antenna.

In one or more embodiments, the first wireless signal RF1 may be transmitted along a path formed in one direction (e.g., the positive X-axis direction) with reference to the central space 635. The second wireless signal RF2 may be transmitted along a path formed in the other direction (e.g., the negative X-axis direction) with reference to the central space 635.

In one or more embodiments, at least a portion (e.g., the second part 612) of the first sheet 610 and at least a portion (e.g., the fourth part 622) of the second sheet 620 may be arranged to overlap each other so that the wireless signal RF generated by the antenna pattern layer 630 is formed substantially parallel to the antenna pattern layer 630. For example, the first wireless signal RF1 and the second wireless signal RF2 may be transmitted along paths formed substantially parallel to the antenna pattern layer 630.

At least a portion of the wireless signal RF of the electronic device 500 (see FIG. 5) according to one or more embodiments may be formed substantially parallel to an antenna pattern layer 630 so as to prevent the wireless signal RF from being affected by other electronic components arranged in the upper direction (e.g., the positive Z-axis direction) and the lower direction (e.g., the negative Z-axis direction) with reference to the antenna 600 or reduce the influence thereof. The wireless signal RF may be transmitted to the outside of the electronic device 500 (see FIG. 5) without being substantially affected by other electronic components arranged in the upper direction (e.g., the positive Z-axis direction) and the lower direction (e.g., the negative Z-axis direction) with reference to the antenna 600.

In one or more embodiments, at least a partial region of the antenna pattern layer 630 may be exposed to the outside of the first sheet 610 and the second sheet 620 without overlapping the first sheet 610 and the second sheet 620 (e.g., without being covered by the first sheet 610 and the second sheet 620). For example, the third region 633 of the antenna pattern layer 630 may not overlap the first sheet 610 and the second sheet 620.

In one or more embodiments, the total area of the antenna pattern layer 630 may mean the sum of the areas of the first surface 630A and the second surface 630B of the antenna pattern layer 630.

In one or more embodiments, an area of approximately ⅔ to ¾ of the total area of the antenna pattern layer 630 may be exposed to the outside of the first sheet 610 and the second sheet 620 without overlapping the first sheet 610 and the second sheet 620 (e.g., without being covered by the first sheet 610 and the second sheet 620). For example, among the entire region of the antenna pattern layer 630, the area of the third region 633, which does not overlap (e.g., is not covered by) the first sheet 610 and the second sheet 620, may be approximately ⅔ to ¾ of the total area of the antenna pattern layer 630.

In one or more embodiments, an area of about ⅔—about ¾ of the total area of the antenna pattern layer 630 may not be covered by the first sheet 610.

In one or more embodiments, an area of about ⅓—about ⅘ of the total area of the antenna pattern layer 630 may not be covered by the first sheet 610.

In one or more embodiments, an area of about ⅔—about ¾ of the total area

of the antenna pattern layer 630 may not be covered by the second sheet 620.

In one or more embodiments, an area of about ⅓—about ⅘ of the total area of the antenna pattern layer 630 may not be covered by the second sheet 620.

In one or more embodiments, an area of about ¼—about ⅓ of the total area of the antenna pattern layer 630 may be covered by the first sheet 610 or the second sheet 620.

In one or more embodiments, an area of about ⅕—about ⅔ of the total area of the antenna pattern layer 630 may be covered by the first sheet 610 or the second sheet 620.

In one or more embodiments, the first sheet 610 may be disposed between the antenna pattern layer 630 and the display 520 (see FIG. 5).

In one or more embodiments, the second sheet 620 may be disposed between the antenna pattern layer 630 and the battery 550 (see FIG. 5).

In one or more embodiments, at least a portion of the antenna pattern layer 630 may not overlap the first sheet 610 and the second sheet 620, and thus the wireless signal RF generated by the antenna pattern layer 630 may have an intensity equal to or higher than a predetermined level.

In one or more embodiments, an area of approximately ¼-⅓ of the total area of the antenna pattern layer 630 may overlap the first sheet 610 or the second sheet 620. For example, an area of approximately ¼-⅓ of the total area of the antenna pattern layer 630 may be covered by the first sheet 610 or the second sheet 620. For example, among the entire region of the antenna pattern layer 630, the sum of the area of the first region 631, which overlaps the first sheet 610 (e.g., is covered by the first sheet 610), and the area of the second region 632, which overlaps the second sheet 620 (e.g., is covered by the second sheet 620), may be approximately ¼ to ⅓ of the total area of the antenna pattern layer 630.

In one or more embodiments, at least a portion of the antenna pattern layer 630 may overlap the first sheet 610 and the second sheet 620 to prevent other components of the electronic device 500 (see FIG. 5) from affecting the wireless signal RF generated by the antenna 600 or reduce the influence thereof.

In one or more embodiments, the first sheet 610 and the second sheet 620 may have a substantially identical shape.

In one or more embodiments, the first sheet 610 and the second sheet 620 may be arranged symmetrically to each other with reference to the central space 635 of the antenna 600. For example, the position, at which the second sheet 620 is disposed, may be a position rotated 180 degrees with reference to the central space 635 of the antenna 600 from the position, at which the first sheet 610 is disposed, and may be a position at which the second surface 630B of the antenna pattern layer 630 is covered.

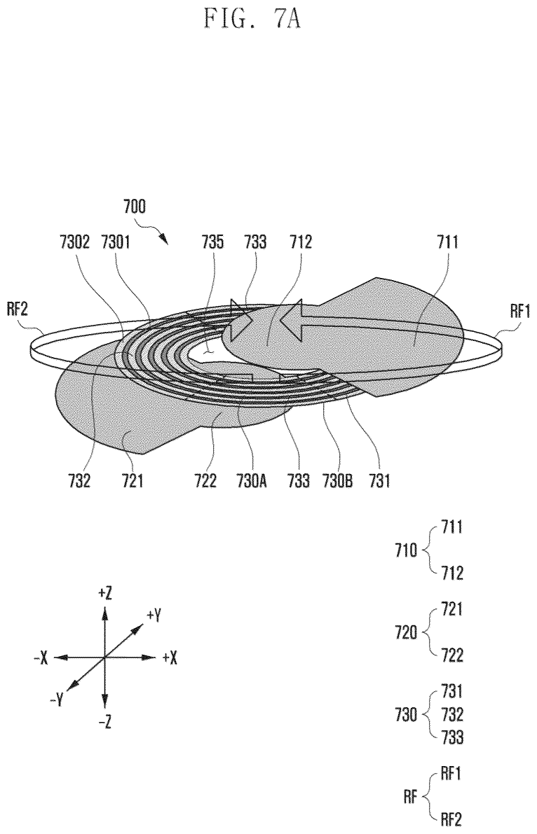

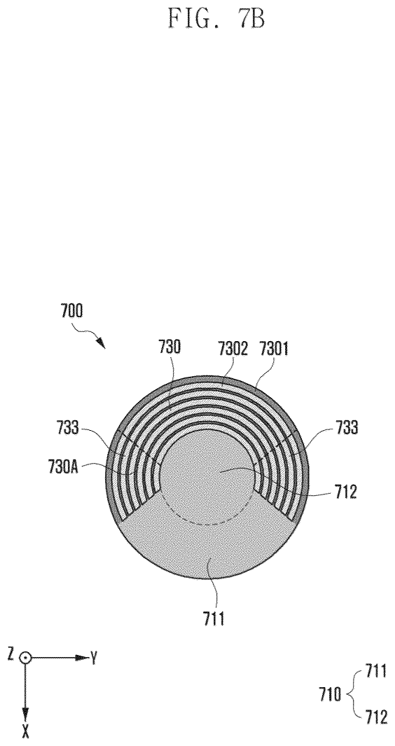

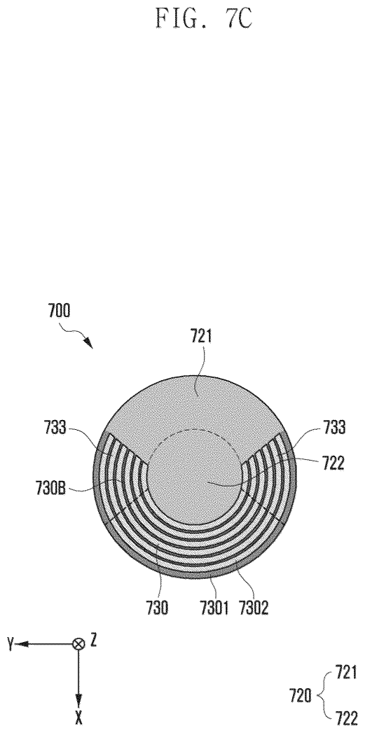

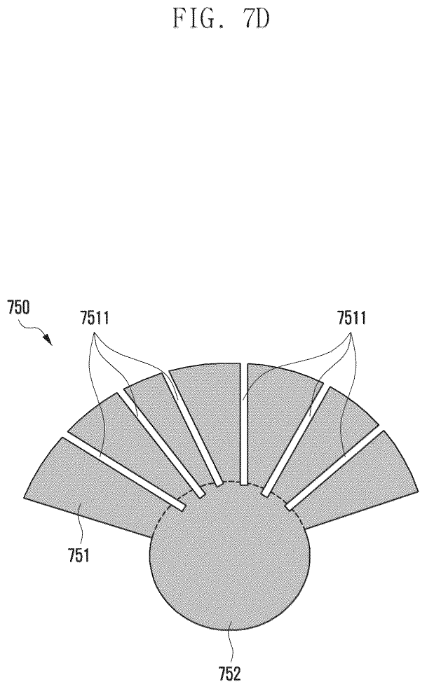

FIG. 7A, FIG. 7B, and FIG. 7C are views showing an antenna 700 according to one or more embodiments of the disclosure.

FIG. 7A is an exploded perspective view showing an antenna 700 according to one or more embodiments. FIG. 7B is a view showing a first surface 730A of an antenna pattern layer 730 according to one or more embodiments. FIG. 7C is a view showing a second surface 730B of an antenna pattern layer 730 according to one or more embodiments. The antenna 700 in FIG. 7A, FIG. 7B, and FIG. 7C may be substantially identical to the antenna 600 in FIG. 6A, FIG. 6B, and FIG. 6C. In describing the antenna 700 in FIG. 7A, FIG. 7B and FIG. 7C, detailed descriptions of the same configuration as the antenna 600 in FIG. 6A, FIG. 6B, and FIG. 6C may be omitted.

Referring to FIG. 7A, FIG. 7B and FIG. 7C, the antenna 700 according to one or more embodiments may include a first sheet 710, a second sheet 720, and/or an antenna pattern layer 730.

In one or more embodiments, the antenna pattern layer 730 may include an antenna pattern 7302 for generating a wireless signal and/or a base layer 7301 having at least a portion on which the antenna pattern 7302 is formed.

In one or more embodiments, with reference to the height direction (e.g., the Z-axis direction) of the antenna 700, the second sheet 720, the antenna pattern layer 730, and the first sheet 710 may be stacked in the described order.

In one or more embodiments, the first sheet 710 and the second sheet 720 may be arranged on opposite surfaces of the antenna pattern layer 730.

In one or more embodiments, the first sheet 710 may be disposed to cover at least a portion of a first surface 730A of the antenna pattern layer 730.

In one or more embodiments, the second sheet 720 may be disposed to cover at least a portion of a second surface 730B of the antenna pattern layer 730, which is a surface opposite to the first surface 730A.

In one or more embodiments, each of the first sheet 710 and the second sheet 720 may include a magnetic material. For example, the first sheet 710 and the second sheet 720 may include ferrite sheets.

In one or more embodiments, each of the first sheet 710 and the second sheet 720 may also not include a magnetic material. For example, each of the material included in the first sheet 710 and the material included in the second sheet 720 is not be limited to the magnetic material. In one or more embodiments, each of the first sheet 710 and the second sheet 720 may be formed of a conductive material or ferroelectrics.

In one or more embodiments, the antenna pattern layer 730 may include a first region 731, a second region 732, and/or a third region 733.

In one or more embodiments, the first region 731 may be a region (e.g., a region covered by the first sheet 710) of the first sheet 710 or the second sheet 720, which overlaps the first sheet 710. For example, the antenna pattern layer 730 may overlap the first sheet 710 positioned on the first surface 730A of the antenna pattern layer 730, in the first region 731.

In one or more embodiments, the second region 732 may be a region (e.g., a region covered by the second sheet 720) of the first sheet 710 or the second sheet 720, which overlaps the second sheet 720. For example, the antenna pattern layer 730 may overlap the second sheet 720 positioned on the second surface 730B of the antenna pattern layer 730, in the second region 732.

In one or more embodiments, the third region 733 may be a region (e.g., a region not covered by the first sheet 710 and the second sheet 720) which does not overlap the first sheet 710 and the second sheet 720. For example, the antenna pattern layer 730 may not overlap both of the first sheet 710 and the second sheet 720, in the third region 733.

In one or more embodiments, the first sheet 710 may include a first part 711 and/or a second part 712.

In one or more embodiments, the first part 711 may be a portion overlapping at least a portion of the antenna pattern layer 730.

In one or more embodiments, the second part 712 may be a portion extending from the first part 711 and overlapping the second sheet 720.

In one or more embodiments, the second sheet 720 may include a third part 721 and/or a fourth part 722.

In one or more embodiments, the third part 721 may be a portion overlapping at least a portion of the antenna pattern layer 730.

In one or more embodiments, the fourth part 722 may be a portion extending from the third part 721 and overlapping the first sheet 710.

Referring to FIG. 7A, the antenna pattern layer 730 may include a central space 735.

In one or more embodiments, the antenna pattern layer 730 may include an antenna pattern 7302 disposed to have a circular loop shape extending to surround the central space 735.

In one or more embodiments, the second part 712 of the first sheet 710 and the fourth part 722 of the second sheet 720 may be arranged to overlap each other in the central space 735.

In one or more embodiments, an area of about ⅔—about ¾ of the total area of the antenna pattern layer 730 may not be covered by the first sheet 710.

In one or more embodiments, an area of about ⅓—about ⅘ of the total area of the antenna pattern layer 730 may not be covered by the first sheet 710.

In one or more embodiments, an area of about ⅔—about ¾ of the total area of the antenna pattern layer 730 may not be covered by the second sheet 720.

In one or more embodiments, an area of about ⅓—about ⅘ of the total area of the antenna pattern layer 730 may not be covered by the second sheet 720.

In one or more embodiments, an area of about ¼—about ⅓ of the total area of the antenna pattern layer 730 may be covered by the first sheet 710 or the second sheet 720.

In one or more embodiments, an area of about ⅕—about ⅔ of the total area of the antenna pattern layer 730 may be covered by the first sheet 710 or the second sheet 720.

In one or more embodiments, the first sheet 710 may be disposed between the antenna pattern layer 730 and the display 520 (see FIG. 5).

In one or more embodiments, the second sheet 720 may be disposed between the antenna pattern layer 730 and the battery 550 (see FIG. 5).

In one or more embodiments, the wireless signal RF may be generated by the antenna pattern layer 730. The wireless signal RF may include a first wireless signal RF1 and/or a second wireless signal RF2.

In one or more embodiments, the first wireless signal RF1 may be transmitted along a path formed in one direction (e.g., the positive X-axis direction) with reference to the central space 735. The second wireless signal RF2 may be transmitted along a path formed in the other direction (e.g., the negative X-axis direction) with reference to the central space 735.

Referring to FIG. 7A, the antenna pattern layer 730 according to one or more embodiments may include a circular shape. Referring to FIG. 7A, FIG. 7B, and FIG. 7C, at least a portion of each of the first sheet 710 and the second sheet 720 according to one or more embodiments may include a fan shape.

In one or more embodiments, the shapes of the antennas 600 and 700 are not be limited to the shapes of the antennas 600 and 700 illustrated in FIG. 6A and FIG. 7A. For example, each of the first sheet 610 or 710 and the second sheet 620 or 720 constituting the antenna 600 or 700 may have a polygonal shape (e.g., a pentagon or a hexagon shape).

FIG. 7D is a view showing a sheet 750 including slits 7511 according to one or more embodiments.

The sheet 750 in FIG. 7D may include at least a portion of elements of the first sheet 710 or the second sheet 720 illustrated in FIG. 7A.

Referring to FIG. 7D, the sheet 750 according to one or more embodiments may include a first part 751 and/or a second part 752. In one or more embodiments, the second part 752 may be a portion among portions of the sheet 750, which overlaps another sheet.

The sheet 750 according to one or more embodiments may include slits 7511 in at least portions thereof. Referring to FIG. 7D, one or more slits 7511 may be formed in the sheet 750. For example, the slits 7511 may be formed in the first part 751 and/or the second part 752 of the sheet 750.

In one or more embodiments, in case that the sheet 750 includes a plurality of slits 7511, the plurality of slits 7511 may be formed while having an interval therebetween.

Referring to FIG. 7D, the plurality of slits 7511 according to one or more embodiments may be arranged irregularly. For example, the plurality of slits 7511 may be arranged such that the intervals between the slits 7511 are not equal.

In one or more embodiments, the plurality of slits 7511 may also be arranged such that the intervals between the slits 7511 are substantially equal. For example, the plurality of slits 7511 may be formed such that the intervals between the slits 7511 are substantially equal, differently from the shape illustrated in FIG. 7D.

The shape of the slits 7511 is not be limited to the shape illustrated in FIG. 7D. For example, in one or more embodiments, the slits 7511 may be formed only in the first part 751 of the sheet 750, or only in the second part 752 of the sheet 750. In one or more embodiments, the slits 7511 may be an opening shape formed in the sheet 750.

Although FIG. 7D illustrates that the slits 7511 are formed in the sheet 750 including a fan shape, the shape of the sheet 750, in which the slits 7511 are formed, is not be limited thereto. For example, in one or more embodiments, the slits 7511 may be formed in the sheet 750 having a quadrilateral shape or a circular shape.

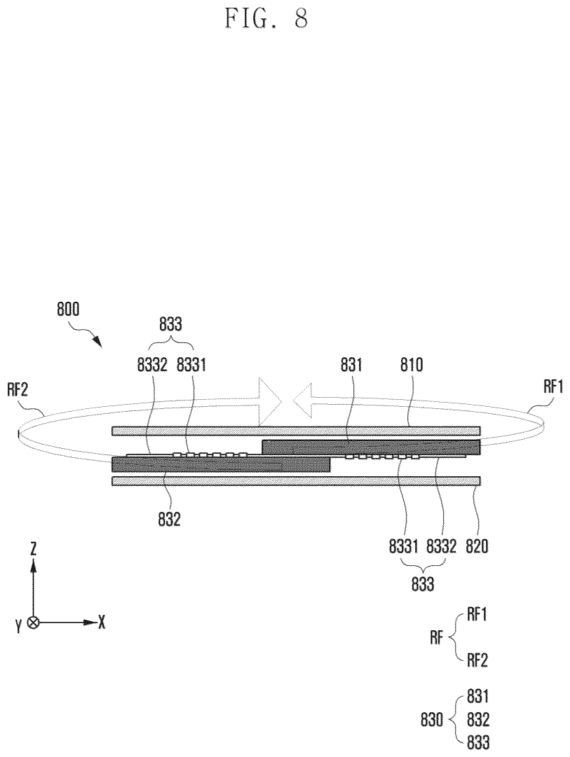

FIG. 8 is a view showing an electronic device 800 according to one or more embodiments of the disclosure.

The electronic device 800 in FIG. 8 may refer to the electronic device 500 in FIG. 5, or may include at least a portion of elements of the electronic device 500 in FIG. 5.

In one or more embodiments, the electronic device 800 may include a first mechanical member 810, a second mechanical member 820, and/or an antenna 830.

In one or more embodiments, the first mechanical member 810 may mean a portion of elements of an electronic device 500 illustrated in FIG. 5. For example, the first mechanical member 810 may mean the display 520 illustrated in FIG. 5.

In one or more embodiments, the second mechanical member 820 may mean a portion of elements of the electronic device 500 illustrated in FIG. 5. For example, the second mechanical member 820 may mean the battery 550 illustrated in FIG. 5.

In one or more embodiments, the antenna 830 may be disposed between the first mechanical member 810 and the second mechanical member 820.

In one or more embodiments, the antenna 830 may include a first sheet 831, a second sheet 832, and an antenna pattern layer 833.

Although FIG. 8 illustrates that the thickness (e.g., the length in the Z-axis direction of the first sheet 831) of the first sheet 831 is thicker than the thickness (e.g., the length in the Z-axis direction of the antenna pattern layer 833) of the antenna pattern layer 833, the thickness of the first sheet 831 is not be limited thereto. For example, in one or more embodiments, the thickness of the first sheet 831 may be thinner than the thickness of the antenna pattern layer 833.

Although FIG. 8 illustrates that the thickness (e.g., the length in the Z-axis direction of the second sheet 832) of the second sheet 832 is thicker than the thickness (e.g., the length in the Z-axis direction of the antenna pattern layer 833) of the antenna pattern layer 833, the thickness of the second sheet 832 is not be limited thereto. For example, in one or more embodiments, the thickness of the second sheet 832 may be thinner than the thickness of the antenna pattern layer 833.

In one or more embodiments, the antenna pattern layer 833 may include an antenna pattern 8331 and/or a base layer 8332. For example, the antenna pattern 8331 may be a conductive layer formed on a base layer 8332 including an insulation material.

In one or more embodiments, the first sheet 831 may be disposed to overlap at least a portion of the antenna pattern layer 833. The first sheet 831 may be disposed on one surface of the antenna pattern layer 833.

In one or more embodiments, the second sheet 832 may be disposed to overlap at least a portion of the antenna pattern layer 833. The second sheet 832 may be disposed on the other surface of the antenna pattern layer 833, which is a surface opposite to the one surface.

In one or more embodiments, the antenna 830 may generate a wireless signal RF. In one or more embodiments, the wireless signal RF may include a first wireless signal RF1 and/or a second wireless signal RF2.

In one or more embodiments, the first sheet 831 and the second sheet 832 may perform a function to guide a movement of the wireless signal RF. For example, the first sheet 831 and the second sheet 832 may guide a movement of the wireless signal RF so that the wireless signal RF moves in a direction substantially parallel to the X-axis direction.

In one or more embodiments, the first wireless signal RF1 may travel along a region in which the first sheet 831 is formed. The second wireless signal RF2 may travel along a region in which the second sheet 832 is formed.

The electronic device 800 according to one or more embodiments of the disclosure may be configured such that the first sheet 831 and the second sheet 832 are arranged on different surfaces of the antenna pattern layer 833, and thus the wireless signal RF generated by the antenna 830 can be radiated in the direction (e.g., the X-axis direction) of the side surface of the antenna 830. For example, the wireless signal RF generated by the antenna (830) may be formed in the vertical direction (e.g., the Z-axis direction) of the antenna 830 and the direction (e.g., the X-axis direction) of the side surface of the antenna 830. In the electronic device 800 according to one or more embodiments of the disclosure, the wireless signal RF formed in the vertical direction (e.g., the Z-axis direction) of the antenna 830 may be prevented from being radiated in the vertical direction (e.g., Z-axis direction) by the first sheet 831 and the second sheet 832. In the electronic device 800 according to one or more embodiments of the disclosure, the wireless signal RF of an antenna 830 may be radiated in a direction (e.g., the X-axis direction or the Y-axis direction) in which the first sheet 831 and the second sheet 832 elongate.

In case that the first sheet 831 and the second sheet 832 are arranged on an identical surface of the antenna pattern layer 833, the wireless signal RF generated by the antenna 830 may be blocked by the first mechanical member 810 and/or the second mechanical member 820.

The electronic device 800 according to one or more embodiments of the disclosure may be configured such that the first sheet 831 and the second sheet 832 are arranged on different surfaces of the antenna pattern layer 833, and thus the wireless signal RF may be radiated without being blocked by the first mechanical member 810 and the second mechanical member 820. For example, the electronic device 800 according to one or more embodiments may be configured such that the wireless signal RF is transmitted to the outside of the electronic device 800 through the first sheet 831 disposed on one surface of the antenna pattern layer 833 and the second sheet 832 disposed on the other surface of the antenna pattern layer 833 without being blocked by the first mechanical member 810 and the second mechanical member 820.

FIG. 9 is a view showing an antenna 900 according to one or more embodiments of the disclosure.

The antenna 900 in FIG. 9 may refer to the antenna 540 in FIG. 5, or may include at least a portion of elements of the antenna 540 in FIG. 5.

An antenna 900 according to one or more embodiments of the disclosure may include a first sheet 910, a second sheet 920, a laminate 930, a third sheet 940, a resin layer 950, a bonding layer 960, and/or a film layer 970.

In one or more embodiments, the antenna 900 may be stacked in the order of the first sheet 910, the second sheet 920, the laminate 930, the third sheet 940, the resin layer 950, the bonding layer 960, and/or the film layer 970, with reference to the height direction (e.g., the Z-axis direction) of the antenna 900.

Although FIG. 9 illustrates two sheets (e.g., the first sheet 910 and the second sheet 920) are arranged in the positive Z-axis direction of the laminate 930 and one sheet (e.g., the third sheet 940) is disposed in the negative Z-axis direction of the laminate 930, the arrangement form of sheets may not be limited thereto. For example, in one or more embodiments, the same number of sheets may also be stacked in the positive Z-axis direction and the negative Z-axis direction of the laminate 930. Alternatively, in one or more embodiments, the number of sheets laminated in the negative Z-axis direction of the laminate 930 may be greater than the number of sheets laminated in the positive Z-axis direction of the laminate 930.

In one or more embodiments, each of the first sheet 910, the second sheet 920, and/or the third sheet 940 may include a magnetic material. For example, each of the first sheet 910, the second sheet 920, and the third sheet 940 may include a ferrite sheet.

In one or more embodiments, each of the first sheet 910, the second sheet 920, and/or the third sheet 940 may not also include a magnetic material. For example, each of the material of the first sheet 910, the material of the second sheet 920, and/or the material of the third sheet 940 is not be limited to a magnetic material. In one or more embodiments, each of the first sheet 910, the second sheet 920, and/or the third sheet 940 may be formed of a conductive material or ferroelectrics.

In one or more embodiments, the resin layer 950 may include an insulating material. For example, the resin layer 950 may include a polyethylene terephthalate (PET) material.

In one or more embodiments, the bonding layer 960 may include a first bonding layer 961 and/or a second bonding layer 962. Each of the first bonding layer 961 and the second bonding layer 962 may include an adhesive material.

In one or more embodiments, the bonding layer 960 may perform a function to bond layers included in the antenna 900. For example, the bonding layer 960 may perform a function to bond the film layer 970 to the resin layer 950 and/or the third sheet 940.

In one or more embodiments, the film layer 970 may be attached to the bonding layer 960. The film layer 970 may include a carrier film.

In one or more embodiments, the laminate 930 may include a first cover layer 931, a first plating layer 932, a base layer 933, a second plating layer 934, and/or a second cover layer 935.

In one or more embodiments, the laminate 930 may mean a flexible copper clad laminate (FCCL) in the form of a flexible printed circuit board.

In one or more embodiments, each of the first plating layer 932 and the second plating layer 934 may include a conductive material. In one or more embodiments, each of the first plating layer 932 and the second plating layer 934 may form an antenna pattern for generating a wireless signal. For example, the first plating layer 932 may be positioned on one surface of the base layer 933, the second plating layer 934 may be positioned on the other surface of the base layer 933, and the first plating layer 932 and the second plating layer 934 may be electrically connected through a via to form a loop-shaped antenna pattern.

In one or more embodiments, each of the first plating layer 932 and the second plating layer 934 may be formed on the base layer 933. The base layer 933 may be an insulation sheet including an insulating material.

In one or more embodiments, the first cover layer 931 may be disposed to cover at least portions of the first plating layer 932 and the base layer 933. The second cover layer 935 may be disposed to cover at least portions of the second plating layer 934 and the base layer 933.

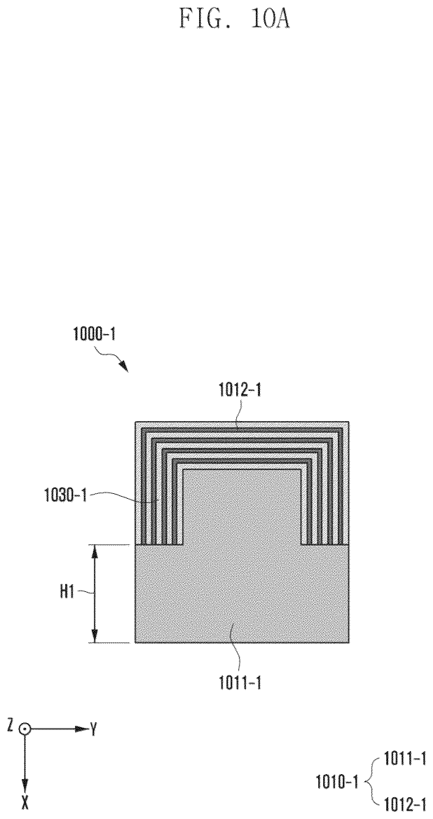

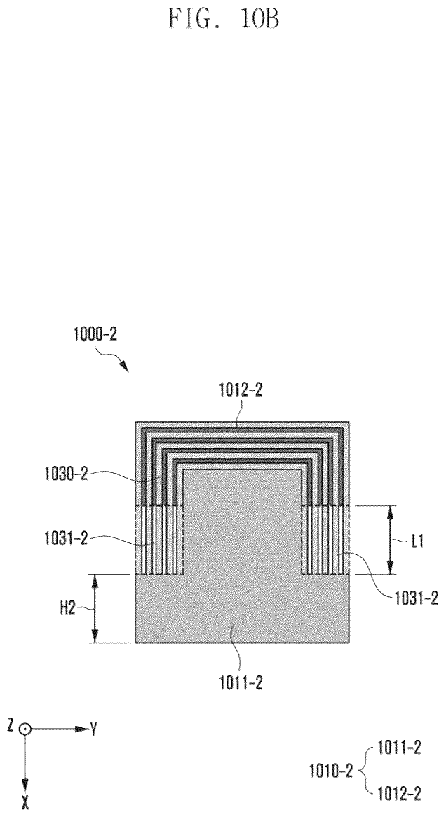

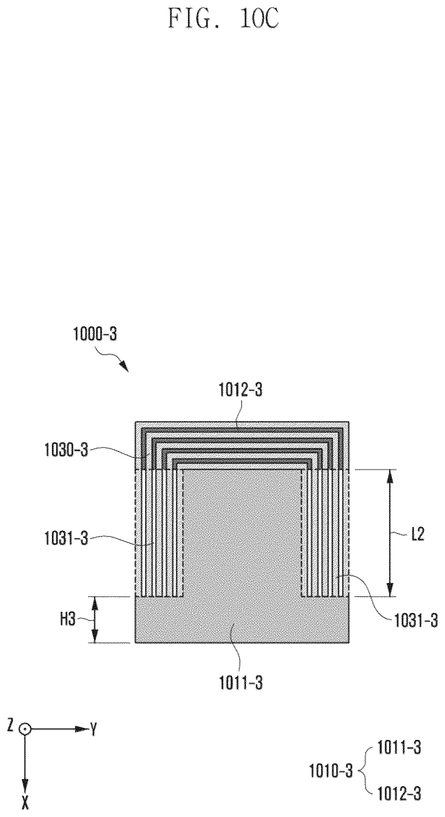

FIG. 10A, FIG. 10B, and FIG. 10C are views showing antennas 1000-1, 1000-2, and 1000-3 according to one or more embodiments.

FIG. 10A is a view showing an antenna 1000-1 according to one or more embodiments. FIG. 10B is a view showing an antenna 1000-2 including a first exposure region 1031-2 according to one or more embodiments. FIG. 10C is a view showing an antenna 1000-3 including a second exposure region 1031-3 according to one or more embodiments.

Each of the antennas 1000-1, 1000-2, and 1000-3 in FIG. 10A, FIG. 10B, and FIG. 10C may refer to the antenna 600 in FIG. 6A, or may include at least a portion of elements of the antenna 600 in FIG. 6A.

Referring to FIG. 10A, the antenna 1000-1 according to one or more embodiments may include a sheet 1010-1 and/or an antenna pattern layer 1030-1. The antenna 1000-1 according to one or more embodiments may be configured such that at least a partial region of the antenna pattern layer 1030-1 overlaps the sheet 1010-1.

FIG. 10A may be a view showing the antenna 1000-1 in which a base layer (e.g., the base layer 6301 in FIG. 6A) is omitted from the antenna pattern layer 1030-1 and only an antenna pattern (e.g., the antenna pattern 6302 in FIG. 6A) is illustrated.

In one or more embodiments, the sheet 1010-1 may include a first sheet 1011-1 and/or a second sheet 1012-1.

In one or more embodiments, the first sheet 1011-1 and the second sheet 1012-1 may be arranged on opposite surfaces of the antenna pattern layer 1030-1. For example, the first sheet 1011-1 may be disposed on one surface of the antenna pattern layer 1030-1, and the second sheet 1012-1 may be disposed on the other surface of the antenna pattern layer 1030-1, the other surface being a surface opposite to the one surface.

Referring to FIG. 10A, the first sheet 1011-1 disposed on the one surface of the antenna pattern layer 1030-1 according to one or more embodiments may have a first width H1.

Referring to FIG. 10B, the antenna 1000-2 according to one or more embodiments may include a sheet 1010-2 and/or an antenna pattern layer 1030-2.

The antenna 1000-2 according to one or more embodiments may be configured such that at least a partial region of the antenna pattern layer 1030-2 does not overlap the sheet 1010-2. According to one or more embodiments, the antenna 1000-2 may be configured such that, among regions of the antenna pattern layer 1030-2, an area of a region which does not overlap the sheet 1010-2 is greater than that of the antenna 1000-1 in FIG. 10A.

FIG. 10B may be a view showing the antenna 1000-2 in which a base layer (e.g., the base layer 6301 in FIG. 6A) is omitted from the antenna pattern layer 1030-2 and only an antenna pattern (e.g., the antenna pattern 6302 in FIG. 6A) is illustrated.

In one or more embodiments, the sheet 1010-2 may include a first sheet 1011-2 and/or a second sheet 1012-2.

In one or more embodiments, the first sheet 1011-2 and the second sheet 1012-2 may be arranged on opposite surfaces of the antenna pattern layer 1030-2. For example, the first sheet 1011-2 may be disposed on one surface of the antenna pattern layer 1030-2, and the second sheet 1012-2 may be disposed on the other surface of the antenna pattern layer 1030-2, the other surface being a surface opposite to the one surface.

Referring to FIG. 10B, the first sheet 1011-2 disposed on the one surface of the antenna pattern layer 1030-2 according to one or more embodiments may have a second width H2. The second width H2 may be smaller than the first width H1.

Referring to FIG. 10B, the antenna pattern layer 1030-2 according to one or more embodiments may include a first exposure region 1031-2 which does not overlap the sheet 1010-2 and is exposed to the outside. For example, the first exposure region 1031-2 may be a region indicated as a dotted box in FIG. 10B. In one or more embodiments, the first exposure region 1031-2 may be formed by a first length L1 in one direction (e.g., the X-axis direction).

In one or more embodiments, the first exposure region 1031-2 may be a region which does not overlap the sheet 1010-2, in the antenna pattern layer 1030-2. For example, the first exposure region 1031-2 may be a region which does not overlap both of the first sheet 1011-2 positioned on one surface (e.g., the surface oriented in the positive Z-axis direction) of the antenna pattern layer 1030-2 and the second sheet 1012-2 positioned on the other surface (e.g., the surface oriented in the negative Z-axis direction) of the antenna pattern layer 1030-2.

Referring to FIG. 10C, the antenna 1000-3 according to one or more embodiments may include a sheet 1010-3 and/or an antenna pattern layer 1030-3.

FIG. 10C may be a view showing the antenna 1000-3 in which a base layer (e.g., the base layer 6301 in FIG. 6A) is omitted from the antenna pattern layer 1030-2 and only an antenna pattern (e.g., the antenna pattern 6302 in FIG. 6A) is illustrated.

In one or more embodiments, the sheet 1010-3 may include a first sheet 1011-3 and/or a second sheet 1012-3.

In one or more embodiments, the first sheet 1011-3 and the second sheet 1012-3 may be arranged on opposite surfaces of the antenna pattern layer 1030-3. For example, the first sheet 1011-3 may be disposed on one surface of the antenna pattern layer 1030-3, and the second sheet 1012-3 may be disposed on the other surface of the antenna pattern layer 1030-3, the other surface being a surface opposite to the one surface.

The antenna 1000-3 according to one or more embodiments may be configured such that at least a partial region of the antenna pattern layer 1030-3 does not overlap the sheet 1010-3. For example, the antenna pattern layer 1030-3 according to one or more embodiments may include a second exposure region 1031-3 which does not overlap the sheet 1010-3 and is exposed to the outside. In one or more embodiments, the second exposure region 1031-3 may be formed by a second length L2 in one direction (e.g., the X-axis direction).

In one or more embodiments, the second exposure region 1031-3 may be a region which does not overlap the sheet 1010-3, in the antenna pattern layer 1030-3. For example, the second exposure region 1031-3 may be a region which does not overlap both of the first sheet 1011-3 positioned on one surface (e.g., the surface oriented in the positive Z-axis direction) of the antenna pattern layer 1030-3 and the second sheet 1012-3 positioned on the other surface (e.g., the surface oriented in the negative Z-axis direction) of the antenna pattern layer 1030-3.

The area of the second exposure region 1031-3 in FIG. 10C may be greater than the area of the first exposure region 1031-2 in FIG. 10B. For example, the second length L2 may be longer than the first length L1.

Referring to FIG. 10C, the sheet 1010-2 disposed on one surface of the antenna pattern layer 1030-3 according to one or more embodiments may have a third width H3. The third width H3 may be smaller than the second width H2.

Referring to FIG. 10A, FIG. 10B, and FIG. 10C, in one or more embodiments, the areas of the regions, which do not overlap the sheets 1010-1, 1010-2, and 1010-3, of the antennas 1000-1, 1000-2, and 1000-3, may be adjusted.

The antenna 1000-2 in FIG. 10B may have a portion which does not overlap the sheet 1010-2 and is exposed to the outside of the sheet 1010-2, and the area of the portion may be greater than that of the antenna 1000-1 in FIG. 10A. For example, since the second width H2 in FIG. 10B is smaller than the first width H1 in FIG. 10A, the area of the antenna 1000-2 covered by the sheet 1010-2 in FIG. 10B may be smaller than that of the antenna 1000-1 in FIG. 10A.

The antenna 1000-3 in FIG. 10C may have a portion which does not overlap the sheet 1010-3 and is exposed to the outside of the sheet 1010-3, and the area of the portion may be greater than that of the antenna 1000-2 in FIG. 10B. For example, since the third width H3 in FIG. 10C is smaller than the second width H2 in FIG. 10B, the area of the antenna 1000-3 covered by the sheet 1010-3 in FIG. 10C may be smaller than that of the antenna 1000-2 in FIG. 10B. Since the second length L2 in FIG. 10C is formed longer than the first length L1 in FIG. 10B, the area of a portion, which is exposed to the outside of the sheet 1010-3, of the antenna 1000-3 in FIG. 10C may be larger than that of the antenna 1000-2 in FIG. 10B.

In one or more embodiments, as the degree, in which the sheet 1010-1, 1010-2, or 1010-3 overlaps the antenna pattern layer 1030-1, 1030-2, or 1030-3, is greater, the antenna can be more prevented or reduced from being influenced by other electronic components.

In one or more embodiments, the performance of the wireless signals generated by the antennas 1000-1, 1000-2, and 1000-3 may differ according to the degree of overlapping between the sheets 1010-1, 1010-2, and 1010-3 and the antenna pattern layers 1030-1, 1030-2, and 1030-3. The antenna 1000-2 in FIG. 10B may have improved performance of the wireless signal, compared to the antenna 1000-1 in FIG. 10A and the antenna 1000-3 in FIG. 10C. The antenna 1000-2 in FIG. 10B may be configured such that the degree (e.g., the degree in which the sheet 1010-2 covers the antenna pattern layer 1030-2), in which the sheet 1010-2 overlaps the antenna pattern layer 1030-2, is formed to a predetermined level, and thus may have improved performance of the wireless signal. For example, the antenna 1000-2 in FIG. 10B may be formed such that an area of approximately 2/3-3/4 of the total area of the antenna pattern layer 1030-2 does not overlap the sheet 1010-2. In case that the performance of the wireless signal measured at the antenna 1000-2 in FIG. 10B is approximately 100, the performance of the wireless signal measured at the antenna 1000-1 in FIG. 10A may be approximately 75, and the performance of the wireless signal measured at the antenna 1000-3 in FIG. 10C may be approximately 70.

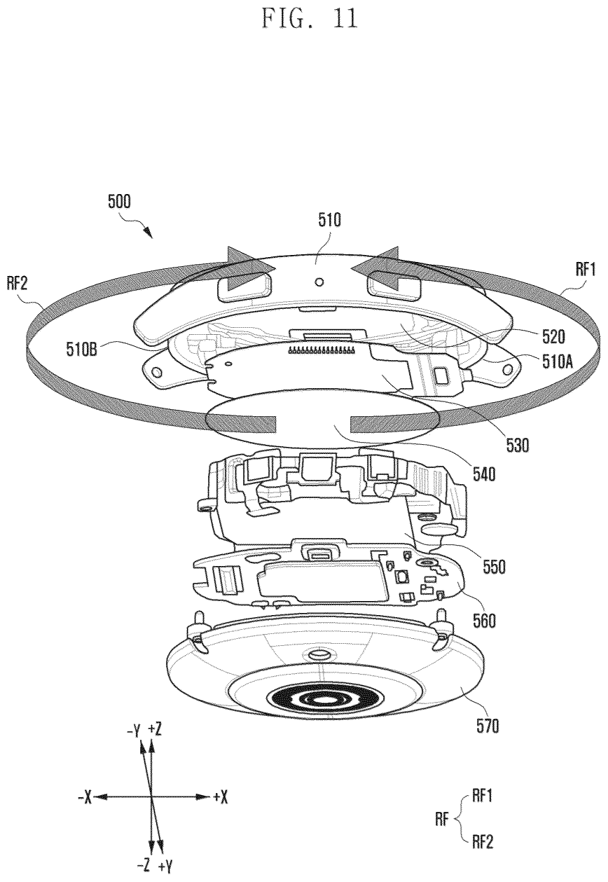

FIG. 11 is a view showing wireless signals RF1 and RF2 of an electronic device 500 according to one or more embodiments of the disclosure.

Referring to FIG. 11, the electronic device 500 according to one or more embodiments of the disclosure may include a housing 510, a display 520, a flexible circuit board 530, an antenna 540, a battery 550, a printed circuit board 560, and/or a rear cover 570.

The antenna 540 illustrated in FIG. 11 may include at least a portion of elements of the antenna 600 in FIG. 6A, the antenna 700 in FIG. 7A, and the antenna 900 in FIG. 9.

In one or more embodiments, the antenna 540 may generate a wireless signal RF. In one or more embodiments, the wireless signal RF may include a first wireless signal RF1 and/or a second wireless signal RF2.

In one or more embodiments, the wireless signal RF radiated from an antenna 540 may have at least a portion formed to be directed toward the side surface of the electronic device 500. For example, at least a portion of the first wireless signal RF1 may be formed around a first side surface 510A of the housing 510. At least a portion of the second wireless signal RF2 may be formed around a second side surface 510B of the housing 510.

In one or more embodiments, at least a portion of the wireless signal RF radiated from the antenna 540 may travel toward the side surface of the electronic device 500, and thus the radiated wireless signal RF can be prevented or reduced from being affected by other electronic components (e.g., the display 520 or the battery 550).

In one or more embodiments, in the electronic device 500, the antenna 540 may be disposed at various positions with reference to the height direction (e.g., the Z-axis direction) of the electronic device 500. Although FIG. 11 illustrates that the antenna 540 is disposed between the display 520 and the battery 550, the position, at which the antenna 540 is disposed, is not limited thereto. For example, in one or more embodiments, the antenna 540 may also be disposed between the printed circuit board 560 and the rear cover 570. Alternatively, in one or more embodiments, the antenna 540 may be disposed on the rear surface (e.g., the surface of the battery 550, which is oriented in the negative Z-axis direction) of the battery 550. For example, the antenna 540 may be disposed between the battery 550 and the printed circuit board 560.

In one or more embodiments, the antenna 540 may include the plurality of antenna pattern layers 630 (see FIG. 6A). For example, in one or more embodiments, the antenna 540 may be formed such that the plurality of antenna pattern layers 630 (see FIG. 6A) are stacked in the height direction (e.g., the Z-axis direction) of the antenna 540. In one or more embodiments, since the strength of the wireless signal RF increases in case that the antenna 540 is formed by stacking the plurality of antenna pattern layers 630 (see FIG. 6A), it may be advantageous to secure a predetermined strength of the wireless signal RF even in case that the electronic device 500 is relatively small.

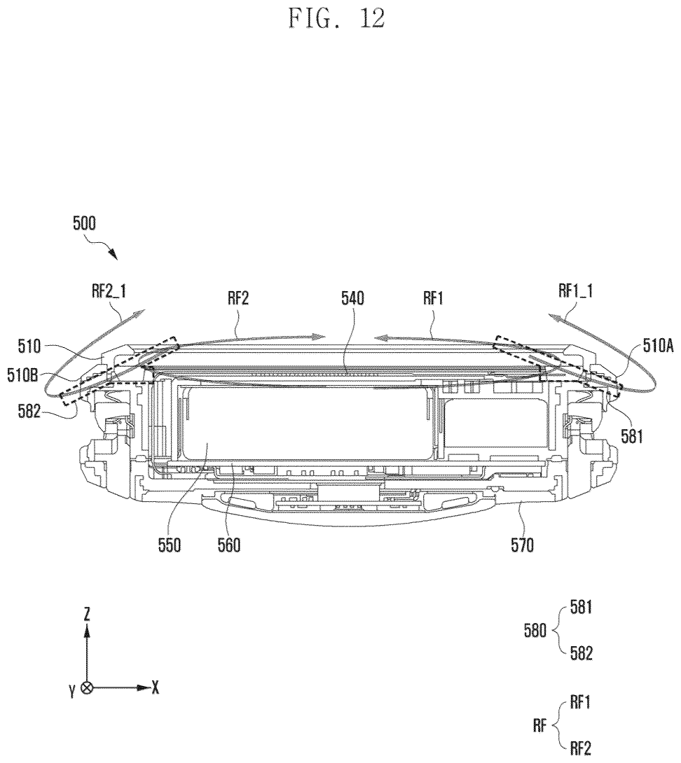

FIG. 12 is a view showing a signal passing region 580 according to one or more embodiments of the disclosure.

Referring to FIG. 12, the electronic device 500 according to one or more embodiments may include a signal passing region 580.

In one or more embodiments, the signal passing region 580 may be a region through which the wireless signal RF generated by the antenna 540 passes. In other words, the signal passing region 580 may be configured to pass the wireless signal RF. For example, the wireless signal RF generated by the antenna 540 may be transmitted to the outside of the electronic device 500 through the signal passing region 580.

In one or more embodiments, the wireless signal RF may include a first wireless signal RF1 and/or a second wireless signal RF2.

In one or more embodiments, the signal passing region 580 may include a first signal passing region 581 and/or a second signal passing region 582. In one or more embodiments, the first signal passing region 581 may be formed in a direction opposite to the second signal passing region 582.

In one or more embodiments, at least a portion (RF1_1) of the first wireless signal RF1 may be transmitted to the outside of the electronic device 500 through the first signal passing region 581.

In one or more embodiments, at least a portion (RF2_1) of the second wireless signal RF2 may be transmitted to the outside of the electronic device 500 through the second signal passing region 582.

Referring to FIG. 12, in the electronic device 500 according to one or more embodiments, the antenna 540 may be disposed above (e.g., in the positive Z-axis direction with reference to the battery 550) the battery 550. The signal passing region 580 may be formed at each of positions in one direction (e.g., the positive X-axis direction) and the other direction (e.g., the negative X-axis direction) with reference to the battery 550, the positions corresponding to the antenna 540.

The antenna 540 is not limited to being positioned in the upper direction (e.g., the positive Z-axis direction with reference to the battery 550) of the battery 550, and the antenna 540 may also be disposed at other positions in the electronic device 500. For example, in one or more embodiments, the antenna 540 may also be disposed between the printed circuit board 560 and the rear cover 570. In this case, the signal passing region 580 may be formed at each of positions in one direction (e.g., the positive X-axis direction) and the other direction (e.g., the negative X-axis direction) of the printed circuit board 560 and the rear cover 570, the positions corresponding to the antenna 540.

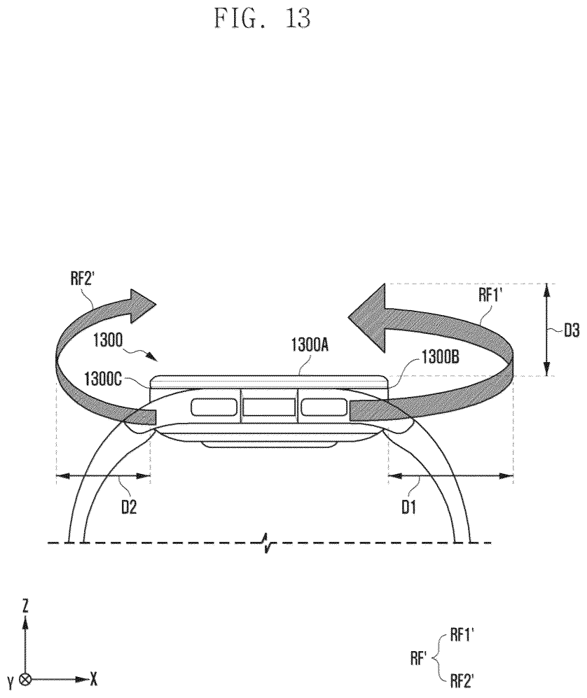

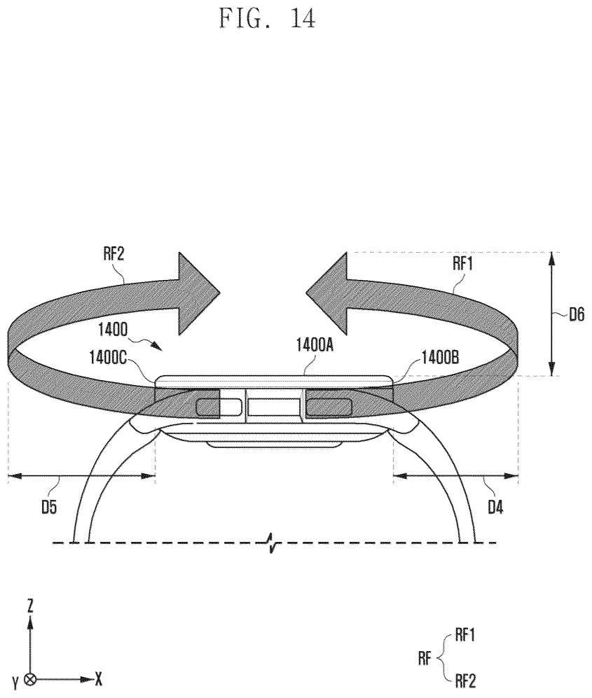

FIG. 13 is a view showing an electronic device 1300 according to a comparative embodiment. FIG. 14 is a view showing an electronic device 1400 according to one or more embodiments of the disclosure.

Referring to FIG. 13, an electronic device 1300 according to a comparative embodiment may generate a wireless signal RF′. The wireless signal RF′ may include a first wireless signal RF1′ and/or a second wireless signal RF2′.

In the comparative embodiment, the first wireless signal RF1′ and the second wireless signal RF2′ may be signals formed in a direction in which at least portions thereof face the side surface of the electronic device 1300. For example, the first wireless signal RF1′ may be a signal formed in a direction in which at least a portion thereof is directed toward a first side surface 1300B of the electronic device 1300. The second wireless signal RF2′ may be a signal formed in a direction in which at least a portion thereof is directed toward a second side surface 1300C of the electronic device 1300.

In the comparative embodiment, the distance, at which the wireless signal RF′ can be recognized from the first side surface 1300B of the electronic device 1300, may be a first distance D1. The first distance D1 may be approximately 85 mm. The distance, at which the wireless signal RF′ can be recognized from the second side surface 1300C of the electronic device 1300, may be a second distance D2. The second distance D2 may be approximately 35 mm. The distance, at which the wireless signal RF′ can be recognized from a front surface 1300A of the electronic device 1300, may be a third distance D3. The third distance D3 may be approximately 65 mm.

In the comparative embodiment, the first wireless signal RF1′ and the second wireless signal RF2′ may be formed asymmetrically with reference to the electronic device 1300. For example, the electronic device 1300 according to the comparative embodiment may be configured such that an antenna is disposed to be biased in one direction in the electronic device 1300, and thus the first wireless signal RF1′ and the second wireless signal RF2′ may be formed asymmetrically. The electronic device 1300 according to the comparative embodiment may be configured such that the first distance D1 at which the wireless signal RF′ can be recognized from the first side surface 1300B of electronic device 1300 and the second distance D2 at which the wireless signal RF′ can be recognized from the second side surface 1300C of the electronic device 1300 are different.

Referring to FIG. 14, an electronic device 1400 according to one or more embodiments of the disclosure may generate a wireless signal RF. The wireless signal RF may include a first wireless signal RF1 and/or a second wireless signal RF2.

In one or more embodiments of the disclosure, the first wireless signal RF1 and the second wireless signal RF2 may be signals formed in a direction in which at least portions thereof face the side surface of the electronic device 1400. For example, the first wireless signal RF1 may be a signal formed in a direction in which at least a portion thereof is directed toward a first side surface 1400B of the electronic device 1400. The second wireless signal RF2 may be a signal formed in a direction in which at least a portion thereof is directed toward a second side surface 1400C of the electronic device 1400.

In one or more embodiments of the disclosure, the distance, at which the wireless signal RF can be recognized from the first side surface 1400B of the electronic device 1400, may be a fourth distance D4. The fourth distance D4 may be approximately 95 mm. The distance, at which the wireless signal RF can be recognized from the second side surface 1400C of the electronic device 1400, may be a fifth distance D5. The fifth distance D5 may be approximately 95 mm. The distance, at which the wireless signal RF can be recognized from a front surface 1400A of the electronic device 1400, may be a sixth distance D6. The sixth distance D6 may be approximately 85 mm.

In one or more embodiments of the disclosure, the first wireless signal RF1 and the second wireless signal RF2 may be formed symmetrically with reference to the electronic device 1400. For example, the electronic device 1400 according to one or more embodiments may be configured such that an antenna is disposed so as not to be biased in one direction in the electronic device 1400, and thus the first wireless signal RF1 and the second wireless signal RF2 may be formed symmetrically. The electronic device 1400 according to one or more embodiments may be configured such that the fourth distance D4 at which the wireless signal RF can be recognized from the first side surface 1400B of electronic device 1400 and the fifth distance D5 at which the wireless signal RF can be recognized from the second side surface 1400C of the electronic device 1400 are substantially the same. That is, the electronic device 1400 according to one or more embodiments may be configured such that the distances, at which the wireless signal RF is recognized, are secured substantially equally, regardless of directions with reference to the electronic device 1400.

The electronic device 1400 according to one or more embodiments of the disclosure may have an increased recognition distance of the wireless signal RF, compared to the electronic device 1300 according to the comparative embodiment. For example, the fourth distance D4 and the fifth distance D5, which are the recognition distance of the wireless signal RF according to one or more embodiments of the disclosure, may be longer than the first distance D1 and the second distance D2 which are the recognition distance of the wireless signal RF′ according to the comparative embodiment. The sixth distance D6, which is the recognition distance of the wireless signal RF according to one or more embodiments of the disclosure, may be longer than the third distance D3 which is the recognition distance of the wireless signal RF′ according to the comparative embodiment.

In case that an NFC antenna is disposed on a printed circuit board, the space, in which components are arranged on the printed circuit board, may be limited.

The NFC antenna may be disposed on the outer portion of the printed circuit board. It may be difficult to dispose a signal wire on the outer portion of the printed circuit board, the NFC antenna being disposed on the outer portion. In addition, it may be difficult to reduce the total thickness of an electronic device due to the thickness of the NFC antenna disposed on the outer portion of the printed circuit board.

In case that the NFC antenna is disposed on the outer portion of the printed circuit board, the position of the NFC antenna may be biased in a specific direction with reference to the center of an electronic device. In this case, the recognition range of the NFC antenna may differ according to the direction thereof.

An electronic device 500 according to one or more embodiments of the disclosure may include a housing 510, a display 520, a battery 550, and an antenna 540, 600, or 700. The display 520 may be disposed in the housing 510. The battery 550 may be disposed in the housing 510. The antenna 540, 600, or 700 may be disposed between the display 520 and the battery 550. The antenna 540, 600, or 700 may include an antenna pattern layer 630 or 730, a first sheet 610 or 710, and a second sheet 620 or 720. The first sheet 610 or 710 may include a (first) ferrite material and may be disposed to cover a portion of a first surface 630A or 730A of the antenna pattern layer 630 or 730. The second sheet 620 or 720 may include a (second) ferrite material, may be disposed to cover a portion of a second surface 630B or 730B of the antenna pattern layer 630 or 730, the second surface being a surface opposite to the first surface 630A or 730A, and may overlap at least a portion of the first sheet 610 or 710. The first ferrite material and the second ferrite material may be the same material or different materials.

In one or more embodiments, a partial region (e.g., the third region 633 or 733) of the antenna pattern layer 630 or 730 may be exposed to the outside of the first sheet 610 or 710 and the second sheet 620 or 720 without being covered by the first sheet 610 or 710 and the second sheet 620 or 720.

In one or more embodiments, the electronic device 500 may include a housing 510 and an antenna 540, 600, or 700.

In one or more embodiments, the electronic device 500 may be a wearable device configured to be attached to or detached from a portion (e.g., the wrist) of the body of a user.

In one or more embodiments, when the antenna pattern layer 630 or 730 is viewed from above (e.g., when viewed in the Z-axis direction), at least a partial region (e.g., the third region 633 or 733) of the antenna pattern layer 630 or 730 may not overlap the first sheet 610 or 710 and the second sheet 620 or 720.

The electronic device 500 according to one or more embodiments of the disclosure may be configured such that the antenna 540, 600, or 700 is separately disposed from the printed circuit board 560, to secure a space in which a component is disposed on the printed circuit board 560.

The electronic device 500 according to one or more embodiments of the disclosure may be configured such that the antenna 540, 600, or 700 is disposed so as not to be biased in a specific direction, to secure substantially identical performance of the antenna 540, 600, or 700 in all directions.

The electronic device 500 or 1400 according to one or more embodiments of the disclosure may have an increased recognition distance of the wireless signal RF, compared to the electronic device 1300 according to the comparative embodiment.

In one or more embodiments, the antenna pattern layer 630 or 730 may include a first region 631 or 731 covered by a first sheet 610 or 710 among the first sheet 610 or 710 or a second sheet 620 or 720, a second region 632 or 732 covered by the second sheet 620 or 720 among the first sheet 610 or 710 or the second sheet 620 or 720, and a third region 633 or 733 not covered by the first sheet 610 or 710 or the second sheet 620 or 720.

In one or more embodiments, the first sheet 610 or 710 may include a first part 611 or 711 overlapping the antenna pattern layer 630 or 730 and a second part 612 or 712 extending from the first part 611 or 711 and overlapping the second sheet 620 or 720.

In one or more embodiments, the second sheet 620 or 720 may include a third part 621 or 721 overlapping the antenna pattern layer 630 or 730 and a fourth part 622 or 722 extending from the third part 621 or 721 and overlapping the first sheet 610 or 710.

In one or more embodiments, the antenna pattern layer 630 or 730 may be formed in a loop shape surrounding a central space 635 or 735, and the second part 612 or 712 of the first sheet 610 or 710 and the fourth part 622 or 722 of the second sheet 620 or 720 may be arranged to overlap the central space 635 or 735.

In one or more embodiments, the second part 612 or 712 of the first sheet 610 or 710 and the fourth part 622 or 722 of the second sheet 620 or 720 may be arranged to cover the antenna pattern layer 630 or 730 at at least a portion.

In one or more embodiments, the first sheet 610 or 710 and the second sheet 620 or 720 may have an identical shape.

In one or more embodiments, an area of ⅔-¾ of the total area of the antenna pattern layer 630 or 730 may not be covered by the first sheet 610 or 710.

In one or more embodiments, an area of ⅓-⅘ of the total area of the antenna pattern layer 630 or 730 may not be covered by the first sheet 610 or 710.

In one or more embodiments, the first sheet 610 or 710 may be disposed between the antenna pattern layer 630 or 730 and the display 520.

In one or more embodiments, an area of ⅔-¾ of the total area of the antenna pattern layer 630 or 730 may not be covered by the second sheet 620 or 720.

In one or more embodiments, an area of ⅓-⅘ of the total area of the antenna pattern layer 630 or 730 may not be covered by the second sheet 620 or 720.

In one or more embodiments, the second sheet 620 or 720 may be disposed between the antenna pattern layer 630 or 730 and the battery 550.

In one or more embodiments, an area of ¼-⅓ of the total area of the antenna pattern layer 630 or 730 may be covered by the first sheet 610 or 710 or the second sheet 620 or 720.

In one or more embodiments, an area of ⅕-⅔ of the total area of the antenna pattern layer 630 or 730 may be covered by the first sheet 610 or 710 or the second sheet 620 or 720.

In one or more embodiments, at least a portion of the antenna pattern layer 630 may not overlap the first sheet 610 and the second sheet 620, and thus the wireless signal RF generated by the antenna pattern layer 630 may have an intensity equal to or higher than a predetermined level.

In one or more embodiments, at least a portion of the antenna pattern layer 630 may overlap the first sheet 610 and the second sheet 620 to prevent other components of the electronic device 500 from affecting the wireless signal RF generated by the antenna 600 or reduce the influence thereof.

In one or more embodiments, an antenna 600 or 700 may include a plurality of antenna pattern layers 630 or 730 stacked in the height direction of the antenna 600 or 700.

In one or more embodiments, since the strength of the wireless signal RF increases in case that the antenna 540 is formed by stacking the plurality of antenna pattern layers 630, it may be advantageous to secure a predetermined strength of the wireless signal RF even in case that the electronic device 500 is relatively small.

In one or more embodiments, the electronic device 500 may include a battery 550 and a display module including a display 520.

In one or more embodiments, the antenna 540 may be positioned between the battery 550 and the display module.

In one or more embodiments, the electronic device 500 may include a printed circuit board 560 disposed in a housing 510 and a rear cover 570 configured to cover at least a portion of the housing 510.

In one or more embodiments, the antenna 540 may be disposed between the printed circuit board 560 and the rear cover 570.

In one or more embodiments, the housing 510 may include a signal passing region 580 through which a wireless signal RF radiated from the antenna 540 passes.

In one or more embodiments, the first sheet 610 or 710 and the second sheet 620 or 720 may be configured to guide the wireless signal RF radiated from the antenna 540 so that at least a portion of the wireless signal travels toward the side surface 510A or 510B of the housing 510.

The technical problems to be achieved in the disclosure are not limited to the technical problems mentioned above, and other technical problems not mentioned can be clearly understood by a person skilled in the art in the technical field to which the disclosure belongs.

The effects obtainable from the disclosure are not limited to the effects mentioned above, and other effects not mentioned will be clearly understood by a person skilled in the art in the technical field to which the disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration.

According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a housing;
a display in the housing;
a battery in the housing; and
an antenna between the display and the battery, wherein the antenna comprises:
an antenna pattern layer comprising an antenna pattern;
a first sheet overlapping a portion of a first surface of the antenna pattern layer; and
a second sheet overlapping a portion of a second surface of the antenna pattern layer, the second surface being opposite to the first surface of the antenna pattern layer and at least partially overlapping the first sheet,
wherein a portion of the antenna pattern is not covered by the first sheet and the second sheet and is exposed to outside of the first sheet and the second sheet.

2. The electronic device of claim 1, wherein the electronic device is a wearable device configured to be wearable on a wrist of a user body.

3. The electronic device of claim 1, wherein the antenna pattern comprises:
a first region covered by the first sheet;
a second region covered by the second sheet; and
a third region not covered by the first sheet and the second sheet.

4. The electronic device of claim 1,
wherein the first sheet comprises:
a first ferrite material;
a first part overlapping with the antenna pattern layer; and
a second part extending from the first part and overlapping with the second sheet,
wherein the second sheet comprises:
a second ferrite material;
a third part overlapping with the antenna pattern layer; and
a fourth part extending from the third part and overlapping with the first sheet.

5. The electronic device of claim 4,
wherein the antenna pattern layer is in a loop shape around a central space, and
wherein the second part of the first sheet and the fourth part of the second sheet overlap the central space.

6. The electronic device of claim 4, wherein the second part of the first sheet and the fourth part of the second sheet overlap the antenna pattern layer at least in part.

7. The electronic device of claim 1, wherein the first sheet and the second sheet have a same shape.

8. The electronic device of claim 1,
wherein ⅔ to ¾ of a total area of the first surface of the antenna pattern layer is not overlapped by the first sheet, and
wherein the first sheet is between the antenna pattern layer and the display.

9. The electronic device of claim 1,
wherein ⅔ to ¾ of a total area of the second surface of the antenna pattern layer is not overlapped by the second sheet, and
wherein the second sheet is between the antenna pattern layer and the battery.

10. The electronic device of claim 1,
wherein ⅓ to ⅘ of a total area of the first surface of the antenna pattern layer is not overlapped by the first sheet, and
wherein the first sheet is between the antenna pattern layer and the display.

11. The electronic device of claim 1,
wherein ⅓ to ⅘ of a total area of the second surface of the antenna pattern layer is not overlapped by the second sheet, and
wherein the second sheet is between the antenna pattern layer and the battery.

12. The electronic device of claim 1,
wherein ¼ to ⅓ of a total area of the antenna pattern layer is overlapped by the first sheet or the second sheet,
wherein the first sheet is between the antenna pattern layer and the display, and
wherein the second sheet is between the antenna pattern layer and the battery.

13. The electronic device of claim 1,
wherein ⅕ to ⅔ of a total area of the antenna pattern layer is overlapped by the first sheet or the second sheet,
wherein the first sheet is between the antenna pattern layer and the display, and
wherein the second sheet is between the antenna pattern layer and the battery.

14. The electronic device of claim 1, wherein the antenna comprises a plurality of the antenna pattern layer stacked in a height direction of the antenna.

15. The electronic device of claim 1, further comprising:
a printed circuit board inside the housing and a rear cover overlapping at least a portion of the housing,
wherein the antenna is between the printed circuit board and the rear cover.

16. The electronic device of claim 1, wherein the housing comprises a signal passing region configured to pass a wireless signal radiated from the antenna.

17. The electronic device of claim 1, wherein the first sheet and the second sheet are configured to guide a wireless signal radiated from the antenna toward a side of the housing.

18. An electronic device comprising:
a housing; and
an antenna in the housing, wherein the antenna comprises:
an antenna pattern layer comprising an antenna pattern;
a first sheet overlapping a portion of a first surface of the antenna pattern layer; and
a second sheet overlapping a portion of a second surface of the antenna pattern layer, the second surface being opposite to the first surface of the antenna pattern layer and at least partially overlapping the first sheet,
wherein a portion of the antenna pattern is not overlapped by the first sheet and the second sheet and is exposed to outside of the first sheet and the second sheet.

19. The electronic device of claim 18, wherein the electronic device is a wearable device configured to be wearable on a wrist of a user body.

20. The electronic device of claim 18, wherein the antenna pattern comprises:
a first region covered by the first sheet;
a second region covered by the second sheet; and
a third region not covered by the first sheet and the second sheet.
